(19) United States
(12) Patent Application Publication
(10) Pub. No.: US 2026/0093956 A1
(43) Pub. Date: Apr. 2, 2026

(54) PARAMETER-FREE ATTENTION

(71) Applicant: QUALCOMM Incorporated, San Diego, CA (US)

(72) Inventors: Hanno ACKERMANN, Amsterdam (NL); Leyla MIRVAKHABOVA, Uithoorn (NL); Hong CAI, San Diego, CA (US); Fatih Murat PORIKLI, San Diego, CA (US); Farhad GHAZVINIAN ZANJANI, Almere (NL); Markus NAGEL, Amsterdam (NL)

(21) Appl. No.: 19/340,783

(22) Filed: Sep. 25, 2025

Related U.S. Application Data
(60) Provisional application No. 63/700,367, filed on Sep. 27, 2024.

(51) Int. Cl. G06N 3/045; G06F 17/16

(52) U.S. Cl. CPC G06N 3/045; G06F 17/16

(57) ABSTRACT

A processor-implemented method for providing parameter-free attention operations includes receiving, by an attention mechanism of a machine learning model, an input. The attention mechanism generates a set of matrices based on the input. An attention matrix is generated based on a reconstruction objective computed based on a linear combination of the input. The machine learning model computes an output based on the attention matrix.

### CROSS-REFERENCE TO RELATED APPLICATION

The present application claims the benefit of U.S. Provisional Patent Application No. 63/700,367, filed on Sep. 27, 2024, and titled “PARAMETER-FREE ATTENTION,” the disclosure of which is expressly incorporated by reference in its entirety.

### FIELD OF THE DISCLOSURE

Aspects of the present disclosure generally relate to machine learning and more particularly to parameter-free attention in machine learning models.

### BACKGROUND

Artificial neural networks (ANNs) are a type of machine learning model. ANNs may comprise interconnected groups of artificial neurons (e.g., neuron models). The ANN may be a computational device or may be represented as a method performed by a computational device. ANNs have numerous applications. In particular, these neural network architectures are used in various technologies, such as image recognition, speech recognition, acoustic scene classification, keyword spotting, autonomous driving, and other classification tasks.

ANN models may process inputs of varying lengths for the different applications. As the input size increases, the computational complexity increases quadratically and may limit the practicality of the ANN model. Attention mechanisms have been proposed to reduce the computational complexity. Attention mechanisms may be designed to mimic human cognitive attention. For instance, given an input (e.g., a sentence), an attention mechanism may be designed to focus the network on more salient portions of the input rather than the entire input. However, conventional attention operations may be computationally expensive with cost on the order of O(N²d) for N nodes and d channels. The conventional attention mechanisms may also use a large memory footprint for storing billions of parameters, which may be challenging for resource-limited computation devices.

### SUMMARY

The present disclosure is set forth in the independent claims, respectively. Some aspects of the disclosure are described in the dependent claims.

Various aspects of the present disclosure are directed to an apparatus. The apparatus has a memory and one or more processors coupled to the memory. The processor(s) is configured to receive, by an attention mechanism of a machine learning model, an input. The processor(s) is also configured to generate, by the attention mechanism, a set of matrices based on the input. The processor(s) is additionally configured to generate an attention matrix based on a reconstruction objective computed based on a linear combination of the input. The processor(s) is further configured to compute, by the machine learning model, an output based on the attention matrix.

In various aspects of the present disclosure, a processor-implemented method performed by at least one processor includes receiving, by an attention mechanism of a machine learning model, an input. The processor-implemented method also includes generating, by the attention mechanism, a set of matrices based on the input. The processor-implemented method additionally includes generating an attention matrix based on a reconstruction objective computed based on a linear combination of the input. The processor-implemented method further includes computing, by the machine learning model, an output based on the attention matrix.

Various aspects of the present disclosure are directed to an apparatus. The apparatus includes means for receiving, by an attention mechanism of a machine learning model, an input. The apparatus also includes means for generating, by the attention mechanism, a set of matrices based on the input. The apparatus additionally includes means for generating an attention matrix based on a reconstruction objective computed based on a linear combination of the input. The apparatus further includes means for computing, by the machine learning model, an output based on the attention matrix.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIGS. 3A and 3B are a block diagrams illustrating a vision-based transformer and a transformer encoder, in accordance with various aspects of the present disclosure.

FIG. 4 is a block diagram illustrating an exemplary software architecture that may modularize artificial intelligence (AI) functions, in accordance with various aspects of the present disclosure.

FIGS. 5 and 6 are block diagrams illustrating conversion of an attention mechanism with a parameter-free attention mechanism, in accordance with various aspects of the present disclosure.

FIG. 7 is a flow diagram illustrating a processor-implemented method for configuring a parameter-free attention mechanism, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Recently, transformer architectures have shown improvement in language modeling and natural language processing (NLP) tasks. Based on transformer architectures such as (but not limited to) bi-directional encoder representations from transformers (BERT), robustly optimized BERT approach (ROBERTa), XLNet, Transformer-XL, and the generative pre-trained transformer (GPT) family of transformers (e.g., GPT-2, GPT-3, GPT-4, etc.), language models may be pre-trained with a large corpora of unlabeled text. Accordingly, such transformer architectures have become popular building blocks in conventional NLP pipelines, as well as in other areas such as computer vision and audio processing.

Transformers for images or videos (e.g., vision transformers (ViTs)) are widely used for computer vision tasks, such as classification, detection, segmentation, and depth estimation, for example. Such vision transformers apply transformer architectures directly to images. Rather than process tokens including portions (words) of text or audio sequences, vision transformers split an image into patches and treat the patches as tokens in an NLP application.

The transformer architectures may rely on attention mechanisms to enable the respective machine learning models (e.g., artificial neural network models) to selectively focus on specific parts of an input sequence. In doing so, an attention mechanism may assign varying degrees of importance to different elements of the input sequence, which may improve the model's ability to capture relevant information and make more informed predictions.

The attention mechanism is an important part of transformer architectures. The attention mechanism enables the machine learning model to compare samples within a sequence or an image, for example. Before the comparison is performed, samples may be multiplied by trainable matrices. The trainable matrices may constitute a significant part of the total number of parameters in transformer models. For instance, the trainable matrices may include about 1.6 billion out of a total of 7 billion parameters. The size of the attention mechanisms may pose problems on systems with limited bandwidth between a graphics processing unit (GPU) and memory, such as mobile computation devices (e.g., a smartphone). Such devices may also have a limitation with respect to on-device memory. The on-device memory may be so limited that the input sequence (e.g., or image) has to be processed in pieces. Because the trainable matrices may be transferred anew for each portion, the bandwidth limitation may be exacerbated.

In addition, activation operations such as soft-argmax may operate slowly on neural processing units (NPUs) because NPUs may have limited memory. Because of the memory limitation, model parameters and data may have to be repeatedly fetched from main memory rather than a local memory. In particular, repeatedly transferring weights between memory and a compute unit (e.g., an NPU) may create a bottleneck because even on expensive accelerators, the memory bandwidth (which refers to the maximum amount of data that can be retrieved in a given time interval) may be limited.

Furthermore, linear layers (e.g., that project input x to query Q, key K, and value V matrices) may be time consuming to run because each involves a large matrix multiplication operation and the matrices have to be transferred from main memory while the bandwidth is limited.

Some conventional approaches propose procedures to compute attention optimized to reduce memory accesses but may only work on specific types of graphics processing units (GPUs) and still utilize weight matrices W_{Q,K,V}. Some other conventional approaches describe sub-quadratic memory usage, but also utilize weight matrices and only work for self-attention.

Accordingly, to address these and other issues, aspects of the present disclosure are directed to parameter-free attention mechanisms. In various aspects, the attention mechanisms may perform the attention operations without using the weight matrices or performing the soft-argmax operation.

Particular aspects of the subject matter described in this disclosure can be implemented to realize one or more of the following potential advantages. In some examples, the described techniques (e.g., generate an attention matrix based on a reconstruction objective computed based on a linear combination of the input) may beneficially reduce memory consumption and inference latency.

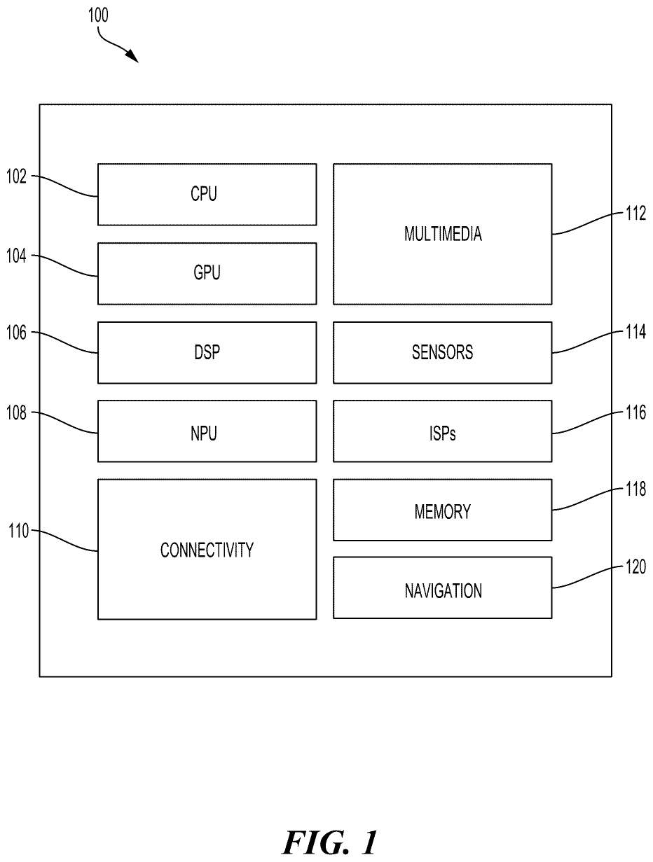

FIG. 1 illustrates an example implementation of a system-on-a-chip (SOC) 100, which may include a central processing unit (CPU) 102 or a multi-core CPU configured for parameter-free attention mechanisms in machine learning models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive, by an attention mechanism of a machine learning model, an input. The instructions loaded into the general-purpose processor 102 may also include code to generate, by the attention mechanism, a set of matrices based on the input. The instructions loaded into the general-purpose processor 102 may additionally include code to generate an attention matrix based on a reconstruction objective computed based on a linear combination of the input. The instructions loaded into the general-purpose processor 102 may further include code to compute, by the machine learning model, an output based on the attention matrix.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

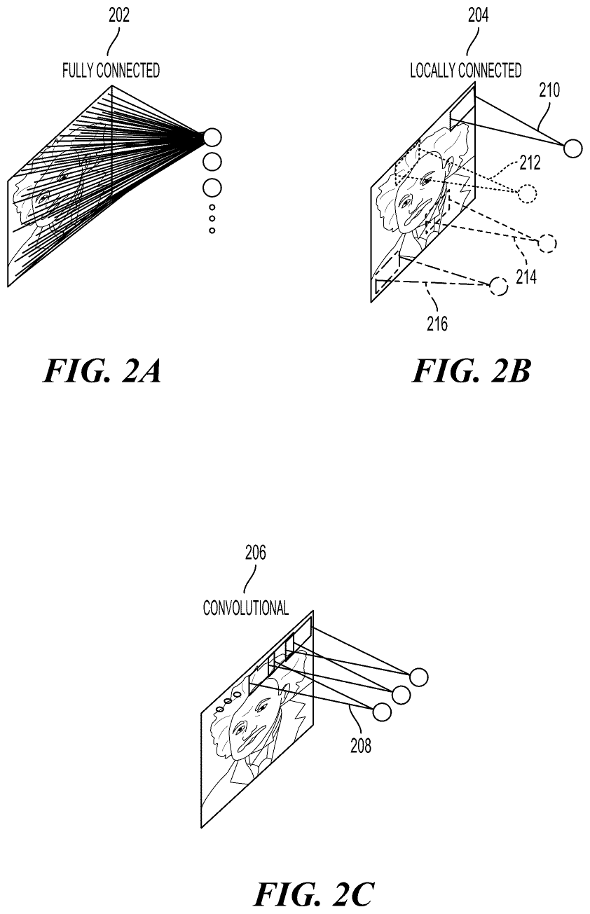

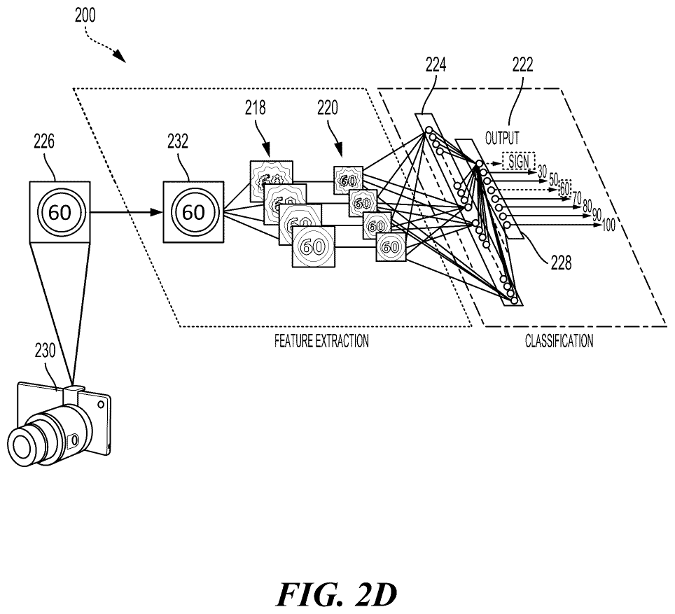

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A soft-argmax function (may also be referred to as “softmax function”) (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “backpropagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

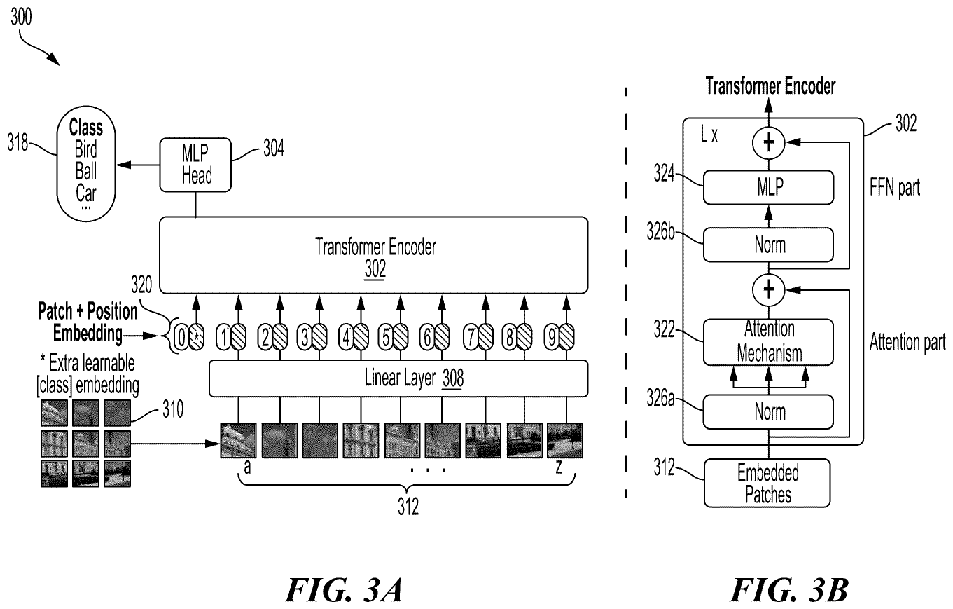

FIGS. 3A and 3B are a block diagrams illustrating a vision-based transformer 300 and a transformer encoder 302, in accordance with various aspects of the present disclosure. Referring to FIG. 3A, the vision-based transformer 300 includes the transformer encoder 302 and a multilayer perceptron (MLP) head 304.

The vision-based transformer 300 may operate in a manner similar to transformers in natural language processing applications. That is, the vision-based transformer 300 may split an input image 310 (shown split into patches of pixels) into multiple patches 312a-z (collectively referred to as image patches 312) that may be treated as tokens (e.g., words). The image patches 312 are supplied to a linear layer 308, which generates a sequence of linear embeddings. Positional embeddings may be added to the linear embeddings to form patch and positional embeddings 320, which may be provided to the conventional transformer encoder 302.

The transformer encoder 302 processes the patch and positional embeddings 320 to determine relationships between the patch and positional embeddings 320 and generates an output. The output is provided to the MLP head 304, which generates a classification 318 for the input image 310.

FIG. 3B shows an expanded view of the transformer encoder 302. The transformer encoder 302 may include alternating layers of attention blocks 322 and MLP blocks 324. A layer norm block 326 (e.g., 326a, 326b) may be applied before every block of the conventional transformer encoder 302. The multi-head attention blocks 322 and MLP blocks 324 may each include a residual connection.

In various aspects, the attention blocks (e.g., 322) may be configured according to the described techniques for parameter-free attention mechanisms.

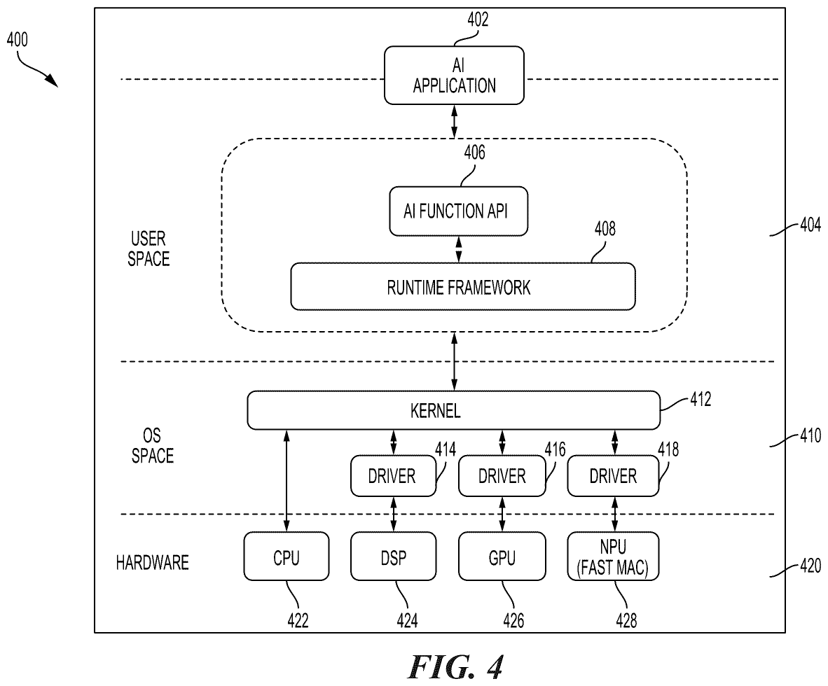

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support parameter-free attention mechanisms for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to parameter-free attention mechanisms. The attention mechanisms may perform the attention operations without using the weight matrices or performing the soft-argmax operation.

Various aspects may focus on the attention mechanism, which allows computing of linear combinations of some so-called value tokens for each query token. Linear mixing weights (usually called attention weights) are determined by computing similarities between the query token and each key token. The number of key tokens equals the number of value tokens. To prevent decay to zero or excessively large magnitudes of the re-mixed tokens, a soft-argmax normalization is applied to the mixing weights. Query, key, and value tokens are created by multiplying input tokens with particular matrices for each set of tokens. For self-attention, the same set of tokens is used to create queries, keys, and values by multiplication with these weight matrices. Conversely, for cross-attention, two different sets of input tokens may be given. One input (b) may create queries, the other input (y) may create both keys and values. The results of the attention mechanism, the linear combinations of the value tokens, can be multiplied by another weight matrix.

The weight matrices can contain a significant number of parameters. For instance, some conventional approaches utilize 7·10⁹ parameters, yet the weight matrices constitute about 30% thereof. In other conventional approaches, the attention weight matrices of transformer blocks of the model may account for 20% and 33% of the parameters of the model encoder and decoder, respectively.

In accordance with various aspects of the present disclosure, a machine learning model (e.g., an artificial neural network) may be received. The machine learning model may, for instance, comprise a transformer model (e.g., transformer encoder 302 of FIG. 3B). The transformer model may include multiple attention mechanisms (e.g., attention blocks 322).

Each of the attention mechanisms (e.g., 322) in the transformer model (e.g., 302) may compare each element of a set of query tokens q₁, . . . , q_{N}, with each of the elements of a set of key tokens k₁, . . . , k_{N}_{_{K}}. The results of these comparisons may be used to linearly combine a set of value tokens v₁, . . . , v_{N}_{_{K}}.

For self-attention, the elements qᵢ, kⱼ, and vⱼ may be generated by multiplying the elements of an input sequence by the weight matrices corresponding to queries W_{q}, keys Wₖ, and values Wᵥ. The weight matrices may have sizes D×D_{q,k,v}, where D_{q,k,v} represents the dimensions of tokens in each of the three sequences qᵢ, kⱼ, and vⱼ. In some aspects, value tokens may have different dimensions D.

Q, K, V∈ [symbol] represent query, key, and value matrices respectively, where N is the sequence length and d is the attention mechanism dimension and d∈ D. An attention output Y∈ [symbol] may be given by the following operations:

$$A = \frac{Q {K}^{T}}{\sqrt{d}} \qquad ( 1 )$$

$$S = σ ( A )$$

$$Y = SV ,$$

where A represents the attention matrix and σ is a soft-argmax function that is applied row-wise. For clarity, the attention matrix may be expressed as:

$${A}_{i j} = \frac{1}{\sqrt{d}} {\sum }_{t = 1}^{d} {Q}_{it} {K}_{jt} \qquad ( 2 )$$

$${S}_{i j} = {σ ( {A}_{i} )}_{j}$$

$${Y}_{it} = {\sum }_{j = 1}^{N} {S}_{ij} {V}_{jt} .$$

On the other hand, for cross-attention, two different sequences may be employed as inputs. For instance, the inputs may correspond to different modalities such as text and video, where the task may be to find correspondence between the text and the video. The queries qᵢ may be generated from one sequence by multiplication with weights W_{q}, whereas the keys kⱼ and values vⱼ may be generated from another sequence by multiplications with weights Wₖ and Wᵥ, respectively. Some transformer models may use three different input sequences.

For multi-head attention, the vectors qᵢ, kⱼ and vⱼ may be split into parts of equal size, for instance

$${q}_{i} = [ \begin{matrix}{q}_{i 1}^{T} & {q}_{i 2}^{T} & … & {q}_{{N}_{H}}^{T}\end{matrix} ]$$

where N_{H} indicates the number of attention heads. The dimensions of qᵢ, kⱼ and vⱼ, D_{q}, Dₖ and Dᵥ are integer-divisible by N_{H}.

Stacking the tokens into matrices Q^{T}=[q₁ . . . ], K^{T}=[k₁ . . . ] and V^{T}=[v₁ . . . ], the attention mechanism may be defined by:

$$\hat{Q} = soft - argmax ( η {QK}^{T} ) V , \qquad ( 3 )$$

where η=D^{-1/2}. The linear combinations of the rows of matrix V yield the rows \hat{q}^{T} of matrix \hat{Q}^{T}.

At each attention mechanism, the nodes in the value set {vⱼ} send update messages vⱼ to the nodes of the query set {qᵢ}. The incoming messages into each node of the query set may be weighted by normalized scalar products soft-argmax

$$( η {q}_{i}^{T} {K}^{T} ) .$$

The incoming messages may be summed-aggregated before the nodes in the query set are updated by an MLP (e.g., 324).

The normalization by the soft-argmax may beneficially limit the size of the sum-aggregated update message from becoming very small or extremely large.

In accordance with aspects of the present disclosure, a reconstruction objective may be imposed. The reconstruction objective may be limited to a small value. The scalars xᵢ, which control the linear combination, may subsume the role of the attention coefficients soft-argmax (ηQK^{T}) in Equation 3. That is, for cross-attention, the attention mechanism for a single row in matrix Q may be represented by omitting the weight matrices W_{Q,K}:

$$single {q}_{i}^{T} ( row in Q ) : {x}_{i} = softmax ( {q}_{i}^{T} \cdot {K}^{T} ) , \qquad ( 4 )$$

where xᵢ denotes mixing coefficients used to re-mix rows of V. The more similar a row of K is to qᵢ (with respect to the scalar product), the larger the corresponding entry in xᵢ, the more the corresponding row in V contributes. That is, the mixing coefficients may enable finding features in V (K, V are derived from the same input in cross-attention) that correlates well with Q. The soft-argmax function may prevent unbounded growth or vanishing of

$${x}_{i}^{T} \cdot V .$$

The mixing coefficients xᵢ may be an Nᵥ-dimensional vector. The reconstruction objective may be given by the product:

$$‖ {q}_{i}^{T} - {x}_{i}^{T} \cdot V ‖ . \qquad ( 5 )$$

The single row of the Q matrix qᵢ may be directly projected to the subspace spanned by V. In this way, information/features in V that align with Q may be determined without calculating the attention matrix and soft-argmax. Then, the soft-argmax function may be replaced using an approximation objective that may be referred to as the reconstruction objective. The reconstruction objective may aim to make the remixed vector V^{T}xᵢ be as similar to qᵢ as possible:

$${min}_{{x}_{i}} \frac{1}{2} {‖ {V}^{T} \cdot {x}_{i} - {q}_{i}^{T} ‖}_{2}^{2} .$$

When the squared l₂-norm is used in Equation 5, the optimal coefficients may be given by

$${x}_{i} = {q}_{i}^{T} {V}^{+ T} ,$$

where the superscript (·)^{+T} indicates the transposed pseudo-inverse. That is, a solution for xᵢ may be obtained by computing a pseudo-inverse based on l₂-norm optimization for cross-attention. Because V is highly correlated between consecutive layers, an iterative solver may be initialized with the solution for xᵢ from a previous layer to accelerate the reconstruction process. In some aspects, the described equation systems may also be solved by an iterative solver such as conjugate gradients or other solution techniques).

The attention reconstruction process may be extended to cover both cross-attention and self-attention. The attention mechanism may be replaced using reconstruction objective that aims to make the remixed vector

$${x}_{i}^{T} \cdot V$$

as similar to qᵢ as possible:

$${min}_{{x}_{i}} \frac{1}{2} {‖ {V}^{T} \cdot {x}_{i} - {q}_{i}^{T} ‖}_{2}^{2} . \qquad ( 6 )$$

As such, qᵢ may be reconstructed using tokens given by the rows of matrix V.

For self-attention, qᵢ is one of the rows of V, so using the pseudo-inverse to estimate solutions of Equation 5, the corresponding entry of xᵢ would be ≈1.0, all other entries ≈0.0. In that case, the attention mechanism may not express qᵢ by other tokens, so the attention mechanism does nothing. On the other hand, if the remixed vector

$${x}_{i}^{T} \cdot V$$

includes other tokens except qᵢ, such tokens may receive gradient information during back propagation. The re-mixed vector

$${x}_{i}^{T} \cdot V$$

may include other vectors to allow for backpropagation into those elements. To prevent the case that the mixing coefficient xᵢ is zero other than for the entry corresponding to qᵢ, either qᵢ has to be removed from V or an iterative solver has to be used so that the entry of the mixing coefficient xᵢ corresponding to qᵢ may be zeroed out at every iteration. Accordingly, an entry of xᵢ corresponding to qᵢ may be zeroed out (e.g., set to zero) using an iterative solver. The iterative solver may be based on l₂-norm optimization for self-attention. In some aspects, only a few nodes in the value set may be allowed to send messages to a particular node qᵢ. Relaxing that constraint may result in a sparse reconstruction problem, which may be solved based on l₁-norm optimization:

$${min}_{{x}_{i}} {‖ {q}_{i}^{T} - {x}_{i}^{T} \cdot V ‖}_{2}^{2} + λ {‖ {x}_{i} ‖}_{1} , \qquad ( 7 )$$

where the scalar λ controls the sparsity and the l₁-norm optimization. An alternating direction method of multipliers (ADMM) technique may introduce an auxiliary variable z. The auxiliary variable z may be coupled to the mixing coefficients xᵢ by an equality constraint in which x−z=0. The reconstruction objective may be augmented by

$${‖ x - z ‖}_{2}^{2} .$$

Thus, the reconstruction objective may be given by:

$$L ( x , z , μ ) = {‖ {q}_{i}^{T} - {x}_{i}^{T} \cdot V ‖}_{2}^{2} + λ {‖ {z}_{i} ‖}_{1} + \frac{ρ}{2} ‖ {x}_{i} - {z}_{i} + μ ‖ - \frac{ρ}{2} ‖ μ ‖ . \qquad ( 8 )$$

The scalar ρ may determine the similarity between x and [symbol] . The reconstruction objective of Equation 8 may be optimized by iterating the following steps:

$${x}^{( k + 1 )} = {( V {V}^{T} + ρ I )}^{- 1} ( {V}_{{q}_{i}} + ρ ( {x}^{( k )} - {z}^{( k )} ) ) \qquad ( 9 a )$$

$${z}^{( k + 1 )} = {τ}_{λ / ρ} ( {x}^{( k )} - {μ}^{( k )} ) \qquad ( 9 b )$$

$${μ}^{( k + 1 )} = {μ}^{( k )} + {x}^{( k + 1 )} - {z}^{( k + 1 )} , \qquad ( 9 c )$$

where τ_{α}(·) in Equation 9b represents a proximal operator, the superscript (k) represents an iteration number, and I represents the identity matrix. Since the token qᵢ is included in one of the rows of V in case of self-attention, the corresponding entry of xᵢ at each iteration may be zeroed-out. Because the process specified in Equation 8 and Equations 9a-9c may not converge, in some aspects, the entries of xᵢ may be clamped to prevent divergence.

Moreover, in various aspects, an inversion of matrix VV^{T}+ρI in Equation 9a may be performed. Because the matrix VV^{T}+ρI is quadratic in the number of tokens in the value set, the matrix VV^{T}+ρI may be very large. Naïvely inverting the matrix VV^{T}+ρI may involve increased memory consumption and inference latency in training the model. However, V is extremely narrow in such cases, usually Nᵥ>>Dᵥ/N_{H}. As such, the eigenvalue decomposition V^{T}V=XDX^{T} can be efficiently computed. Because the non-zero eigenvalues of VV^{T} equal those of V^{T}V, only the left singular vectors Y≈VD^{-1/2}X of V may be used because the left singular vectors may equal the eigenvectors of VV^{T} corresponding to the non-zero eigenvalues. Thereby, updates may be efficiently computed:

$${x}^{( k + 1 )} = {YS}^{- 1} ( {Y}^{T} ( {V}_{{q}_{i}} + ρ ( {x}^{( k )} - {z}^{( k )} ) ) ) , \qquad ( 10 )$$

without ever allocating memory for the possibly large inverse. The matrix S results from adding ρ to the diagonal of D. To avoid exploding gradients during backpropagation, r·I may be added to the diagonal of V^{T}V where the entries of r may be drawn from a uniform distribution [symbol] (0, σ) with σ being small.

After some training, the matrix of value tokens V may degenerate. That is, many of the eigenvalues of V^{T}V may become very small. Additional iterations may be performed, thus slowing down forward and backward passes through the machine learning model and increasing memory demand. Furthermore, a rank-deficiency may prevent the ADMM from reaching a reasonable solution if the query qᵢ is far from the range space span (V^{T}V). The rank deficiency may not appear in the ADMM due to the term+ρI in Equation 9a, which may serve as a regularizer, (e.g., the Tikhonov-regularizer may prevent rank-deficiency).

Instead of reverting to a slower and memory-intensive formulation, such as in Equation 9a, a set of tokens whose entries are drawn from a normal distribution may be generated. These random tokens may then be appended to V. As such, the eigenvalues of V^{T}V may increase. In addition, appending random tokens to V may enable the left singular vectors Y to have components that point to the kernel, thereby enabling the regression of components of qⁱ, which may be in the kernel space. For instance, if H random tokens are appended, Y is (Nᵥ+H)×D/N_{H}.

In some aspects, the entries of the final x^{k} may be mapped by a function ƒ and normalized to, for instance, sum 1. To avoid using the expensive soft-argmax function, the function may be defined as

$$f ( {x}_{i j} ) = {x}_{i j}^{p}$$

where p may ve taken to be 4 or 5.

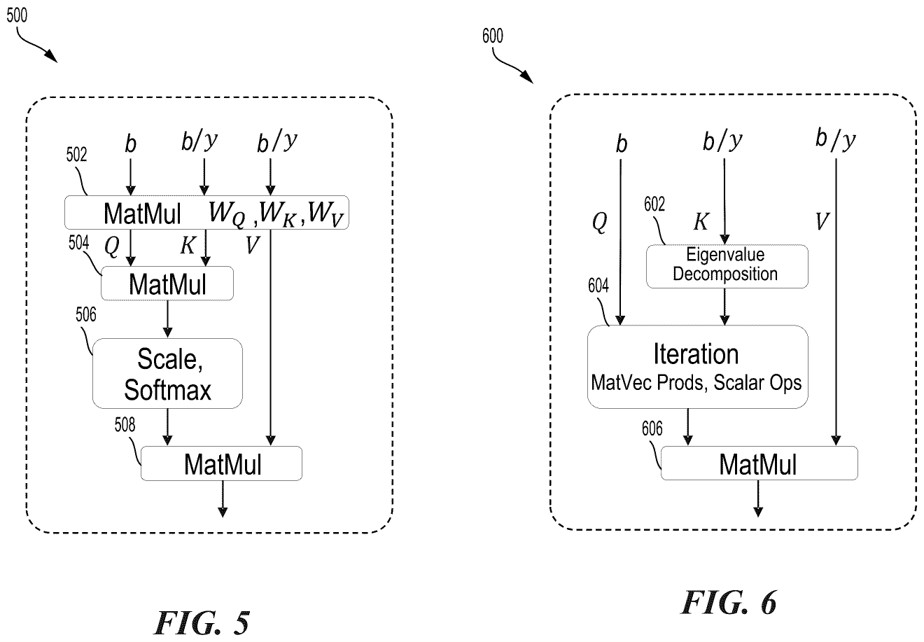

FIGS. 5 and 6 are block diagrams illustrating a conversion of an attention mechanism 500 with a parameter-free attention mechanism 600, in accordance with various aspects of the present disclosure. Referring to FIG. 5, the attention mechanism 500 may be configured similar to the attention block 322 of FIG. 3B. In block 502, weight matrices W_{Q}, W_{K} and W_{V} may be retrieved from memory and applied to the inputs (b for self-attention, or b and y for cross-attention) to generate the matrices Q, K, and V. In block 504, a scalar multiplication of the Q matrix and K matrix may be performed. In block 506, the product of the scalar multiplication may be normalized (e.g., scaled) and subjected to a soft-argmax function. Then, in block 508, the V matrix may be multiplied by the soft-argmax output to produce the attention matrix.

Referring to FIG. 6, the attention mechanism 500 may be reconstructed as the parameter-free attention mechanism 600, which computes the attention matrix without retrieving the weight parameters (e.g., W_{q}, Wₖ and Wᵥ). In addition, the parameter-free attention mechanism 600 may compute the attention matrix without computing the soft-argmax function. The parameter-free attention mechanism 600 may receive as inputs b for self-attention (or b and y for cross-attention). In some aspects, the parameter-free attention mechanism 600 may also receive the scalar ρ. Given that Q=B, the K matrix may be determined at block 602, by computing the inverse (V^{T}V+ρI)⁻¹ with efficient eigenvalue decomposition as indicated in Equation 9a.

At block 604, an iterative process occurs for computing the matrix vector products and scalar operations to compute x^{k} as indicated in Equations 9a-9c. Then, at block 606, a matrix multiplication operation may compute the attention matrix as the product of x^{k} and the V matrix.

In some aspects, a singular value decomposition of matrix V may be performed to

$$V : V = U Σ {Y}^{T} ⇒ {V}^{T} V = Y {Σ}^{2} {Y}^{T} ⇒ {( {V}^{T} V )}^{- 1} = Y {Σ}^{\frac{1}{2}} {Y}^{T} ,$$

where V∈m×n with n>>m, U∈m×m, Y∈n×n.

Furthermore, in some aspects, an eigenvalue decomposition may be performed in which VV^{T}=UDU^{T}⇒\tilde{Y}^{T}=D^{1/2}U^{T}A, where \tilde{Y}∈m×n, (e.g., much smaller than Y). Accordingly, the pseudo-inverse may be approximated as

$${( ( {V}^{T} V ) + ρ I )}^{- 1} \approx {\tilde{Y}}^{T} {Σ}^{- \frac{1}{2 + ρ}} \tilde{Y}$$

with Σ=D^{1/2}. As a result, memory consumption and inference latency may be further reduced.

Accordingly, the parameter-free attention mechanism 600 may replace an attention block of any transformer or vision transformer. For instance, the parameter-free attention mechanism 600 may replace the attention block 322 of FIG. 3B. In turn, the machine learning model (e.g., 302) may be operated to generate an output (e.g., an inference) based on the attention matrix generated using the parameter-free attention mechanism 600. Accordingly, the memory bottleneck of repeatedly loading weight matrices from main memory onto a processor (e.g., NPU 108/428) for each matrix multiplication to compute the attention matrix may be reduced, and in some aspects, may be alleviated.

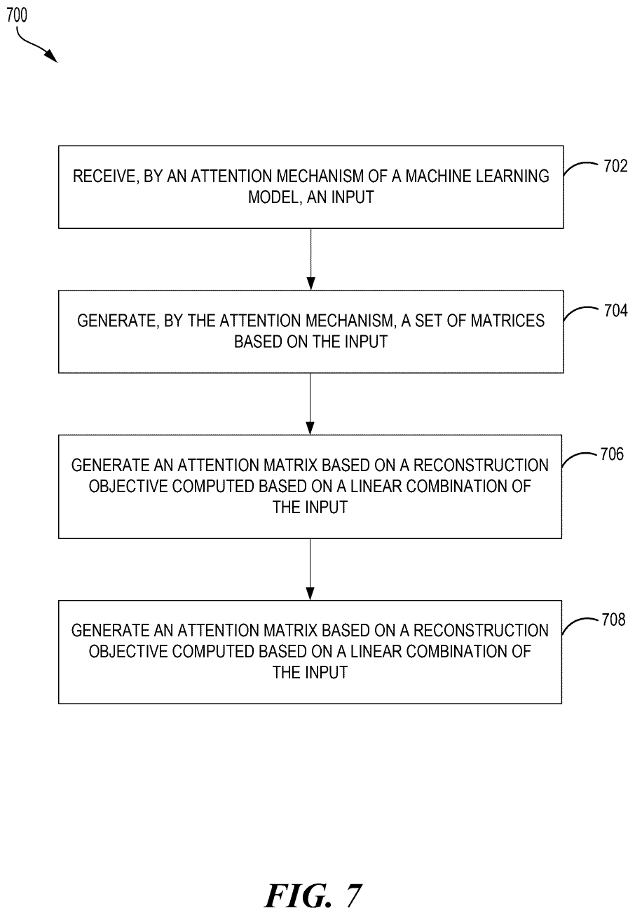

FIG. 7 is a flow diagram illustrating a processor-implemented method 700 for configuring a parameter-free attention mechanism, in accordance with various aspects of the present disclosure. The processor-implemented method 700 may be performed by one or more processors such as the CPU (e.g., 102, 422), GPU (e.g., 104, 426), and/or other processing unit (e.g., DSP 424, NPU 428), for example.

Referring to FIG. 7, at block 702, the one or more processors receive, by an attention mechanism of a machine learning model, an input. For example, as described, with respect to FIG. 6, the parameter-free attention mechanism 600 may receive as inputs b for self-attention (or b and y for cross-attention).

At block 704, the one or more processors generate, by the attention mechanism, a set of matrices based on the input. For example, as described with reference to FIG. 6, Given that Q=B, the K matrix may be determined at block 602, by computing the inverse (V^{T}V+ρI)⁻¹ with efficient eigenvalue decomposition as indicated in Equation 9a.

At block 706, the one or more processors generate an attention matrix based on a reconstruction objective computed based on a linear combination of the input. For instance, as described with reference to FIG. 6, at block 604, an iterative process occurs for computing the matrix vector products and scalar operations to compute x^{k} as indicated in Equations 9a-9c. Then, at block 606, a matrix multiplication operation may compute the attention matrix as the product of x^{k} and the V matrix.

At block 708, the one or more processors compute, by the machine learning model, an output based on the attention matrix. As described, for example with reference to FIG. 6, the parameter-free attention mechanism 600 may replace an attention block of any transformer or vision transformer. For instance, the parameter-free attention mechanism 600 may replace the attention block 322 of FIG. 3B. In turn, the machine learning model (e.g., 302) may be operated to generate an output (e.g., an inference) based on the attention matrix generated using the parameter-free attention mechanism 600.

### Example Aspects

Aspect 1: An apparatus, comprising: at least one memory; and at least one processor coupled to the at least one memory, the at least one processor configured to: receive, by an attention mechanism of a machine learning model, an input; generate, by the attention mechanism, a set of matrices based on the input; generate an attention matrix based on a reconstruction objective computed based on a linear combination of the input; and compute, by the machine learning model, an output based on the attention matrix.
Aspect 2: The apparatus of Aspect 1, wherein the at least one processor is further configured to compute the reconstruction objective based on a remixing vector that determines a correlation of features between a first matrix in the set of matrices and a second matrix in the set of matrices.
Aspect 3: The apparatus of Aspect 1 or 2, wherein the at least one processor is further configured to compute the attention matrix using a pseudo-inverse of a third matrix of the set of matrices.
Aspect 4: The apparatus of any preceding Aspect, wherein the at least one processor is further configured to approximate the pseudo-inverse using an eigenvalue decomposition technique.
Aspect 5: The apparatus of any preceding Aspect, wherein the at least one processor is further configured to apply an iterative solver based on l₂-norm optimization to generate the attention matrix.
Aspect 6: The apparatus of any preceding Aspect, wherein the at least one processor is further configured to apply a parameter that controls an l₁-norm optimization to reconstruct the attention matrix.
Aspect 7: A processor-implemented method performed by at least one processor, the processor-implemented method comprising: receiving, by an attention mechanism of a machine learning model, an input; generating, by the attention mechanism, a set of matrices based on the input; generating an attention matrix based on a reconstruction objective computed based on a linear combination of the input; and computing, by the machine learning model, an output based on the attention matrix.
Aspect 8: The processor-implemented method of Aspect 7, further comprising computing the reconstruction objective based on a remixing vector that determines a correlation of features between a first matrix in the set of matrices and a second matrix in the set of matrices.
Aspect 9: The processor-implemented method of Aspect 7 or 8, further comprising computing the attention matrix using a pseudo-inverse of a third matrix of the set of matrices.
Aspect 10: The processor-implemented method of any of Aspects 7-9, further comprising approximating the pseudo-inverse using an eigenvalue decomposition technique.
Aspect 11: The processor-implemented method of any of Aspects 7-10, further comprising applying an iterative solver based on l₂-norm optimization to generate the attention matrix.
Aspect 12: The processor-implemented method of any of Aspects 7-11, further comprising applying a parameter that controls an l₁-norm optimization to reconstruct the attention matrix.
Aspect 13: An apparatus comprising: means for receiving, by an attention mechanism of a machine learning model, an input; means for generating, by the attention mechanism, a set of matrices based on the input; means for generating an attention matrix based on a reconstruction objective computed based on a linear combination of the input; and means for computing, by the machine learning model, an output based on the attention matrix.
Aspect 14: The apparatus of Aspect 13, further comprising means for computing the reconstruction objective based on a remixing vector that determines a correlation of features between a first matrix in the set of matrices and a second matrix in the set of matrices.
Aspect 15: The apparatus of Aspect 13 or 14, further comprising means for computing the attention matrix using a pseudo-inverse of a third matrix of the set of matrices.
Aspect 16: The apparatus of any of Aspects 13-15, further comprising means for approximating the pseudo-inverse using an eigenvalue decomposition technique.
Aspect 17: The apparatus of any of Aspects 13-16, further comprising means for applying an iterative solver based on l₂-norm optimization to generate the attention matrix.
Aspect 18: The apparatus of any of Aspects 13-17, further comprising means for applying a parameter that controls an l₁-norm optimization to reconstruct the attention matrix.

In one aspect, the receiving means, means for generating, by the attention mechanism a set of matrices, means for generating an attention matrix, and/or computing means may be the CPU 102/422, GPU 104/426, program memory associated with the CPU 102/422 or GPU 104/426, fully connected layers 362, NPU 108/428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor configured to:
receive, by an attention mechanism of a machine learning model, an input;
generate, by the attention mechanism, a set of matrices based on the input;
generate an attention matrix based on a reconstruction objective computed based on a linear combination of the input; and
compute, by the machine learning model, an output based on the attention matrix.

2. The apparatus of claim 1, wherein the at least one processor is further configured to compute the reconstruction objective based on a remixing vector that determines a correlation of features between a first matrix in the set of matrices and a second matrix in the set of matrices.

3. The apparatus of claim 1, wherein the at least one processor is further configured to compute the attention matrix using a pseudo-inverse of a third matrix of the set of matrices.

4. The apparatus of claim 3, wherein the at least one processor is further configured to approximate the pseudo-inverse using an eigenvalue decomposition technique.

5. The apparatus of claim 1, wherein the at least one processor is further configured to apply an iterative solver based on l₂-norm optimization to generate the attention matrix.

6. The apparatus of claim 1, wherein the at least one processor is further configured to apply a parameter that controls an l₁-norm optimization to reconstruct the attention matrix.

7. A processor-implemented method performed by at least one processor, the processor-implemented method comprising:
receiving, by an attention mechanism of a machine learning model, an input;
generating, by the attention mechanism, a set of matrices based on the input;
generating an attention matrix based on a reconstruction objective computed based on a linear combination of the input; and
computing, by the machine learning model, an output based on the attention matrix.

8. The processor-implemented method of claim 7, further comprising computing the reconstruction objective based on a remixing vector that determines a correlation of features between a first matrix in the set of matrices and a second matrix in the set of matrices.

9. The processor-implemented method of claim 7, further comprising computing the attention matrix using a pseudo-inverse of a third matrix of the set of matrices.

10. The processor-implemented method of claim 9, further comprising approximating the pseudo-inverse using an eigenvalue decomposition technique.

11. The processor-implemented method of claim 7, further comprising applying an iterative solver based on l₂-norm optimization to generate the attention matrix.

12. The processor-implemented method of claim 11, further comprising applying a parameter that controls an l₁-norm optimization to reconstruct the attention matrix.

13. An apparatus comprising:
means for receiving, by an attention mechanism of a machine learning model, an input;
means for generating, by the attention mechanism, a set of matrices based on the input;
means for generating an attention matrix based on a reconstruction objective computed based on a linear combination of the input; and
means for computing, by the machine learning model, an output based on the attention matrix.

14. The apparatus of claim 13, further comprising means for computing the reconstruction objective based on a remixing vector that determines a correlation of features between a first matrix in the set of matrices and a second matrix in the set of matrices.

15. The apparatus of claim 13, further comprising means for computing the attention matrix using a pseudo-inverse of a third matrix of the set of matrices.

16. The apparatus of claim 15, further comprising means for approximating the pseudo-inverse using an eigenvalue decomposition technique.

17. The apparatus of claim 13, further comprising means for applying an iterative solver based on l₂-norm optimization to generate the attention matrix.

18. The apparatus of claim 17, further comprising means for applying a parameter that controls an l₁-norm optimization to reconstruct the attention matrix.
